(19) United States
(12) Patent Application Publication
(10) Pub. No.: US 2012/0061949 A1
(43) Pub. Date: Mar. 15, 2012

(54) METHOD FOR PERSONALIZING A PRINTED MATTER AND ATTACHMENT THEREFOR

(76) Inventors: Éric Azara, Hampstead (CA); Willy Marion, Montreal (CA); René Ilardi, Plan De Cuques (FR)

(21) Appl. No.: 13/202,758

(22) PCT Filed: Feb. 18, 2010
(86) PCT No.: PCT/CA2010/000226

§ 371 Date: Nov. 9, 2011

(30) Foreign Application Priority Data
Feb. 23, 2009 (CA) 2655127

(51) Int. Cl. B42D 15/00

(52) U.S. Cl. 283/81

(57) ABSTRACT

A method for producing a printed matter personalized for a subscriber is provided. More specifically, the present invention relates to a method allowing offset printing of common sections of the printed matter and of personalizable attachments, which personalizable attachments may be personalized and assembled to the common sections of the printed matter. The present invention also relates to personalizable attachments for personalizing printed matters such as magazines, newspaper and the like.

### FIELD OF THE INVENTION

The present invention generally relates to a method for personalizing a printed matter. More specifically, the present invention relates to a method allowing offset printing of common sections of the printed matter and of personalizable attachments, which personalizable attachments may be personalized by digital printing or the like and assembled to the common sections of the printed matter.

### BACKGROUND OF THE INVENTION

Offset printing is the cheapest method to produce high quality printing in commercial printing quantities. It is therefore widely used to print magazines and the like.

However, time and costs associated with producing plates and printing press setup make this method cost ineffective for very small quantity printing jobs, therefore making it unsuitable for personalization of the printed matter. Yet, customization or personalization of printed matter may be desirable for marketing and advertisement purposes, for instance.

Small quantity printing jobs such as those involving personalization now tend to move to digital printing machines. However, digital printing machines tend to produce images of inferior quality, especially with pictures, and tend to be less cost-effective than offset printing. Accordingly, digital printing tends to be of limited use in high-volume commercial printing involving images, such as magazines.

Some have thus proposed to combine the advantages of offset printing and more flexible printing methods, such as digital printing. For instance U.S. Pat. No. 5,143,362 issued to Doane discloses a method and apparatus for the personalization of magazines and the like. This method comprises printing a signature with variable, personalized printing, assembling the personalized signature with at least one other signature, detecting the personalized printing on the signature and printing the subscribers address on the cover based on the personalized printing. This method may also comprise the step of assembling the signature with other business documents, such as business reply envelopes.

This method has the disadvantage of requiring an additional detection or scanning step to determine the identity of the personalized signature and to print the address of the subscriber accordingly. In addition of requiring sophisticated scanning equipment, this additional step tends to delay production. Further, the personalization of the signature section rather than the cover pages tends to reduce marketing efficiency of the personalization, thus making it less interesting for advertisers.

Some others have proposed the personalization of the magazine content for the different subscribers. Examples can be found in U.S. Pat. Nos. 3,917,252; 4,022,455 and 5,114,128. Essentially, different sets of signature pages are produced, each set being then matched with a corresponding group of subscribers. Such a method has the disadvantage that it cannot provide a personalized printed matter for each subscriber.

Therefore, it would be desirable to be provided with a method for economically producing high-volumes of high quality printed matters and yet be able to personalize such printed matters. It would also be desirable to be provided with a method that enables personalizing the cover page of the printed matter to maximize the efficiency of such customization.

### SUMMARY OF THE INVENTION

According to one embodiment, there is provided an attachment for personalizing a printed matter to a subscriber of the printed matter. More specifically, there is provided an attachment for personalizing a printed matter having a front page and a back page, the attachment comprising: (a) a sheet of material sized and shaped for covering at least a portion of at least one of the top page and the bottom page; (b) means for attaching the attachment to the printed matter such that the sheet of material covers at least a portion of the at least one of the top page and the bottom page; and (c) at least one personalized marketing material printed on the sheet of material.

According to another embodiment, the printed matter is selected from a group consisting of a magazine, a circular, a catalogue, a directory, a book, a pamphlet, and a newsletter.

According to yet another embodiment, the sheet of material is selected from a group consisting of a sheet of paper, a sheet of cardboard, a sheet of plastic and a sheet of fabric.

According to a further embodiment, the attachment is selected from a group consisting of a label, a sleeve, a tab, a half-jacket and a cover.

According to another embodiment, the personalized marketing material is selected from a group consisting of a personal greeting, a publicity targeted to the subscriber, a link to a personalized web page, an information relating to the subscriber and a printed matter content of interest for the subscriber.

According to yet another embodiment, the attachment further comprises a coordinate of the subscriber. Preferably, the coordinate comprises at least one of a name of the subscriber and a mailing address.

According to a further embodiment, the means for attaching is selected from a group consisting of glue, staple, tape and insertion slots.

According to another embodiment, there is provided a method for personalizing a printed matter. The method comprises: providing a plurality of subscribers, each of the subscribers having a personal profile comprising a mailing address; compiling the personal profiles of the subscribers in a database; providing a plurality of personalized marketing materials in the database; associating each of the personal profiles with one corresponding personalized marketing material; generating a plurality of common sections of a printed matter; generating a corresponding plurality of personalizable attachments of the printed matter; personalizing each of the personalizable attachments by printing thereon one of the personalized marketing materials to thereby obtain a plurality of personalized sections, the personalized message printed on each personalizable section being selected based on the personal profiles; assembling each of the personalized sections with one of the common sections to obtain a plurality of personalized printed matters; providing the mailing address of each of the subscribers on the personalized printed matter; and sending the personalized printed matters to the subscribers.

According to another embodiment, the mailing address of each of the subscribers' is provided on the personalized attachment.

According to another embodiment, the attachments are selected from a group consisting of a label, a sleeve, a tab, a half-jacket and a cover.

According to yet another embodiment, the marketing materials are selected from a group consisting of a personal greeting, a publicity targeted to the subscriber, a link to a personalized web page, an information relating to the subscriber and a printed matter content of interest for the subscriber.

These and other objects, advantages and features of the present invention will become more apparent to those skilled in the art upon reading the details of the invention more fully set forth below.

### BRIEF DESCRIPTION OF THE FIGURES

Having thus generally described the nature of the invention, reference will now be made to the accompanying drawings, showing by way of illustration illustrative embodiments thereof, and in which:

FIG. 1 is a front perspective view of a personalized printed matter in accordance with one embodiment, with the personalizable attachment detached from the cover page;

FIG. 2 is a front view of the printed matter shown in FIG. 1, with the personalizable attachment affixed to the cover page;

FIG. 3 is a front view of a personalized printed matter in accordance with another embodiment, showing the personalizable attachment thereof partially lifted;

FIG. 4 is a front view of a personalizable printed matter in accordance with a further embodiment, showing the personalized attachment thereof partially lifted;

FIG. 5 is a front perspective view of a personalizable printed matter in accordance with another embodiment;

FIG. 6 is a back perspective view of the personalizable printed matter shown in FIG. 5;

FIG. 7 is a front perspective view of the personalizable printed matter shown in FIG. 5, with the personalized message printed on the front cover page;

FIG. 8 is a back perspective view of the personalizable printed matter shown in FIG. 6, with the personalized message printed on the back cover page;

FIGS. 9A and 9B are a flow chart illustrating a method for personalizing a printed matter in accordance with one embodiment.

Further details of the invention and its advantages will be apparent from the detailed description included below.

### DETAILED DESCRIPTION OF THE INVENTION

In the following description of the embodiments, references to the accompanying drawings are by way of illustration of an example by which the invention may be practiced. It will be understood that other embodiments may be made without departing from the scope of the invention disclosed.

It is to be noted that the expression “printed matter” is to be construed herein and in the appended claims as any permanent or semi-permanent support suitable to receive printed information thereon including any kind of paper or binded or attached sheets of paper, having printed information thereon, and is intended to include, without limitation, newspaper, magazine, newsletter, prospectus, etc.

The expression “printed element” is to be construed herein and in the appended claims as any textual, graphical or photographical element or a combination thereof, including drawings, which can be included on a page of a printed medium.

The terms “publicity” or “marketing material” are also to be taken herein and in the appended claims in their broadest interpretation so as to mean any words, images, pictures or a combination thereof intended for selling a good or a service directly or indirectly. This includes, without limitations, advertisements, promotional offers, product placement, corporate logo, and the like.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

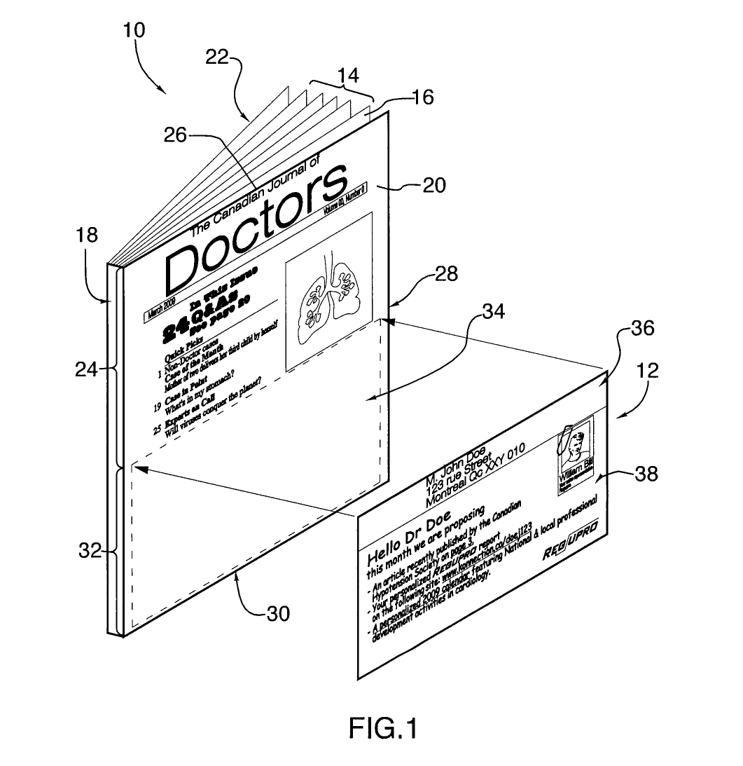

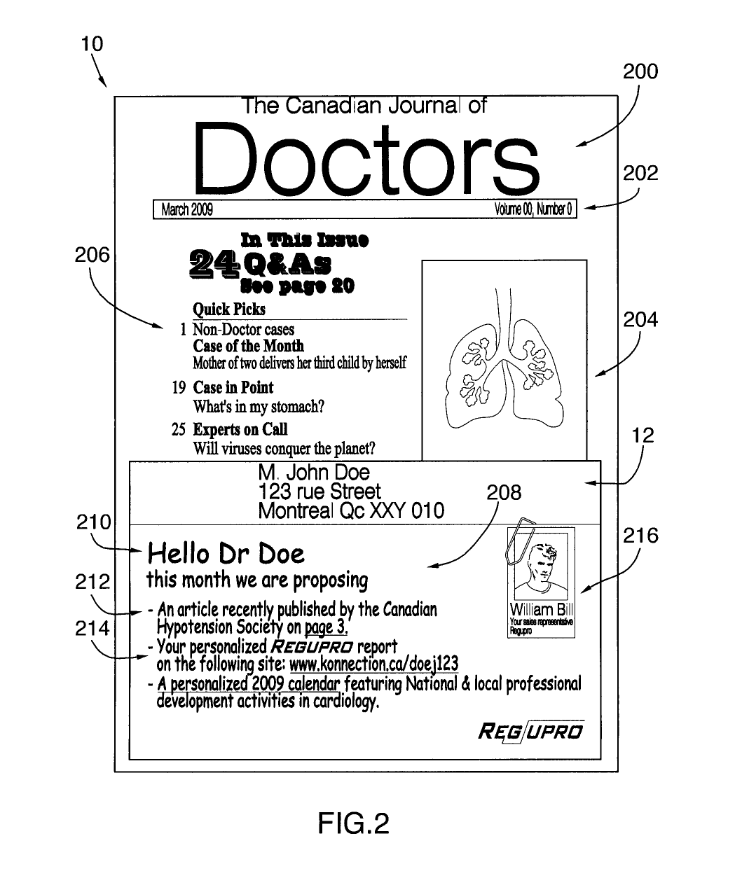

With reference to FIGS. 1 and 2, there is shown a printed matter in the form of a magazine 10 provided with a personalized attachment 12 in accordance with one embodiment of the present invention. The magazine 10 comprises a signature section 14 including a plurality of pages 16 bound to one another. For covering the signature section 14 and providing an aesthetic character to the magazine 10, a personalizable cover 18 is provided. The personalizable cover 18 comprises a front cover page 20 and a back cover page 22.

According to the embodiment shown in FIGS. 1 and 2, the front page 20 of the personalizable cover 18 comprises an upper portion 24 extending between a top edge 26 to and intermediate region 28 located generally halfway between the top edge 26 and a bottom edge 30, and a lower portion 32. The lower portion 32 extends between the intermediate region 28 and the bottom edge 30.

As best shown in FIG. 1, prior to affixing the customizable attachment 12 to the cover personalizable 18 of the magazine 10, printed elements typically displayed on magazine covers such as the title 200 of the magazine, the volume and issue 202, a picture 204 and magazine content 206, are provided but only in the upper portion 24 of the front cover page 20. The printed elements displayed in the upper portion 24 of the front cover page 20 correspond to information that all subscribers will receive (i.e. the common printed elements). The lower portion 32 of the front cover page 22 is left blank to provide a space 34 for later affixing the personalized attachment 12 to the magazine, as it will become apparent below. According to the embodiment shown in FIGS. 1 and 2, the space 34 has a rectangular shape. A person skilled in the art will appreciate that the space 34 could have any other shape. Further, the person skilled in the art will appreciate that the space 34 could be provided in the upper portion 24 rather than in the lower portion 32. In such an embodiment, the common printed elements “(i.e. title 200, volume and issue 202, picture 204 and magazine content 206)” would be displayed in the lower portion 32. Alternatively, the space 34 could extend vertically (i.e. between the top and bottom edges 26 and 30), the common printed elements and the attachment 12 being displayed in a side-by-side relationship.

The signature section 14 and the personalizable cover 18 of the magazine are printed and assembled as known in the art. A person skilled in the art will appreciate that in this embodiment the signature section 14 and personalizable cover 18 of all magazines are identical (i.e. regardless of the subscriber to which the magazine 10 is sent). Accordingly, the magazine can be printed and assembled without being personalized. A person skilled in the art will appreciate that the signature 14 and the personalized cover 18 can be stapled, glued or otherwise bound to one another.

According to one embodiment, the personalizable attachment 12 is in the form of a label and is sized and shaped to fit within the space 34 provided of the lower portion 32 of the front cover page 20. According to the embodiment shown in FIGS. 1 and 2, the personalizable attachment 12 is thus rectangular. A person skilled in the art will appreciate that the size and shape of the attachment is adapted to fit within the space 34 and that multiple configurations are possible.

The personalizable attachment 12 comprises an upper coordinate portion 36 for printing the coordinates of a subscriber and a lower marketing portion 38. The upper coordinate portion is configured for 36 displaying the subscriber coordinates, which include the name and mailing address of the magazine subscriber, but may vary depending on the means of delivery used. For instance, only the name or the mailing address may be required in some applications.

While in this embodiment the subscriber coordinates are to be printed in the coordinate portion 36 of the personalized attachment 12, a person skilled in the art will appreciate that the subscriber coordinates (i.e. name and mailing address) may be printed elsewhere. For instance, in accordance with an alternate embodiment, the subscriber's coordinates may be printed directly onto the front or back cover pages 20, 22 using known digital printing technique.

The marketing portion 38 is configured for displaying personalized marketing material 208 targeted to each subscriber. The marketing material displayed in the marketing portion 38 may contain personal information related to the subscriber to create the impression that the printed matter has been prepared exclusively for him or for her. Therefore, according to one embodiment, the personalized marketing material 208 includes a personalized greeting 210 displayed so as to readily attract the attention of the subscriber. The personalized greeting 210 is preferably displayed using bold typeface so as to maximize the visual impact thereof. Colors, contrast with the background, text positioning, or other well-known marketing technique can be used to highlight the personal greeting 210. The marketing portion 38 may further include information selected to make the subscriber feel that the magazine has been published especially for him, such as, for instance the magazine content that may be of particular interest for that subscriber 212 as well as a link to a web page dedicated to the subscriber 214, as best described below.

Examples of personal information which can be used to personalize the marketing portion 38 of the customizable attachment 12 includes the name of the subscriber, a picture related thereto (e.g. his or her picture) information provided in response to a survey including (e.g. favorite sport and hobby), the subscriber's place of birth, occupation, and the like. The marketing portion 38 may further include publicity targeted for the subscriber based on his personal profile. A person skilled in the art will appreciate that the marketing portion 38 can display any other type of information that is targeted to the subscriber, such as targeted advertising or contact information 216 to reach a customer representative assigned to the particular subscriber, for instance, based on his geographical location.

According to one first embodiment, the content of the marketing portion 38 is selected on the basis of the subscriber's personal profile. As it will become apparent below, the subscriber's personal profile is preferably retrieved from a subscriber's database that includes the personal profiles of all magazine subscribers. Such database may include, for instance, the customer database of an editor of the magazine 10, a database of an advertiser, a database of a publicist or any combination thereof. The personal profile of each subscriber includes his or her name, mailing address, telephone number, subscription information and the like. The subscribers' personal profiles consolidated in the database may include information collected at the time of subscription, in response to surveys and the like. The personal profile of each subscriber may also include his internet profile or browsing activity (e.g. which of the advertiser's web pages have been consulted by a subscriber, how much time was spent by the subscriber on each web page consulted, etc.). In such case, the internet profile of each subscriber may be updated from time to time as the subscriber accesses his dedicated web page, as it will become apparent below.

The database is preferably configured for associating the personal profile of each subscriber with a particular content to the printed matter in the marketing portion 38. In one embodiment, the database is also configured for commanding the printing of the subscriber's name and mailing address in the coordinate portion 36 and the selected content in the marketing portion 38, as best described below.

Prior to sending the magazine 10 to the subscriber, the personalizable attachment 12 must be personalized to each subscriber and 6 affixed to the front cover page 20, in the space 34 of the lower portion 32. According to one embodiment, the personalizable attachment is personalized by printing the subscriber's coordinates in the coordinate portion 36 and the marketing material in the marketing portion 38. The printing of these elements is preferably carried out using a digital printer, though a skilled person will acknowledge that it could be done using a different type of printer. Upon personalization of the personalizable attachment 12 (i.e. now a personalized attachment), the same is affixed to the front cover page 20. In one embodiment, glue is applied to one of the front cover page 20, in the space 34, or to the back of the personalized attachment 12 and the attachment glued to the front cover page 20 using techniques known in the art. In an alternate embodiment, the personalized attachment 12 may be affixed to the front cover page 20 using a sticker or adhesive tape.

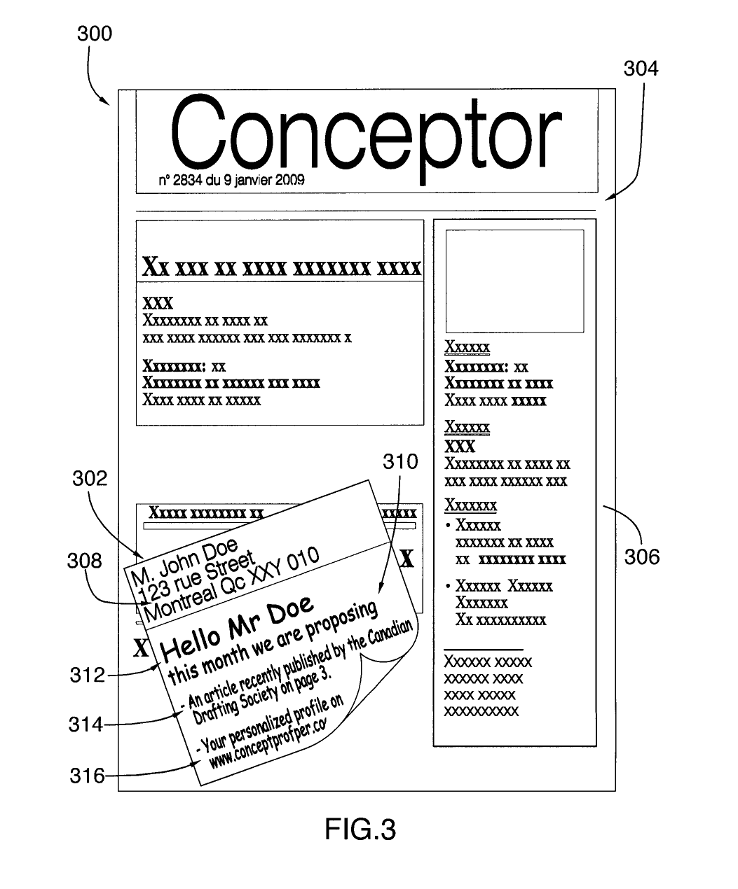

Now turning to FIG. 3, a magazine 300 comprising a personalizable attachment 302 in accordance with an alternate embodiment is shown. In this embodiment, the magazine comprises a cover 304 including a front cover page 306. Contrary to front cover page 20 of the magazine 10, which is provided with space 34, the front cover page 306 of the magazine 300 is exempted from a specific space for receiving the attachment 302

More specifically, in this embodiment, the personalizable attachment 302 is in the form of a paper tab and comprises a coordinate portion 308 and a marketing portion 310. The coordinate portion 308 of personalizable attachment 302 is similar to coordinate portion 36 of personalizable attachment 12 and displays the same type of information (i.e. name and mailing address of the subscriber). Likewise, the marketing portion 310 of the personalizable attachment 302 is similar to the marketing portion 38 of personalizable attachment 12. Accordingly, the marketing portion 310 of the personalizable attachment displays personalized marketing material or publicity that includes a personalized greeting 312 displayed so as to readily attract the attention of the subscriber, the magazine content that may be of particular interest for that subscriber 314 and a link to a web page dedicated to the subscriber 316. The marketing portion 310 may comprise other marketing material such as, for instance, advertising. The subscriber's coordinates and the marketing material are preferably printed in the coordinate and marketing portions 308, 310 using a digital printer.

According to a preferred embodiment, the personalizable attachment 302 is made from paper. However, in alternate embodiments, the personalizable attachment 302 may be made of another material, such as aluminium or other metal foil, cardboard, polymeric sheet, and any other type of sheet material. According to a further embodiment, the personalizable attachment 302 may be replaced by a piece of a flexible sheet of a printable or engravable material. The sheet can be of any size and thickness as allowed by the magazine printing and shipment process.

For affixing the personalizable attachment 302 to the cover page 304 of the magazine 300, the top portion of the personalizable attachment 302 is glued onto the cover 304 while the lower portion remains unglued. This configuration allows the subscriber to lift the lower portion of the personalizable attachment 302 to visualize the portion of the front cover page 306 hidden by the personalized attachment 302. The personalizable attachement 302 may be affixed, for instance, using a permanent glue, a sticker, an adhesive tape, a fugitive glue or a re-adherable strip of adhesive.

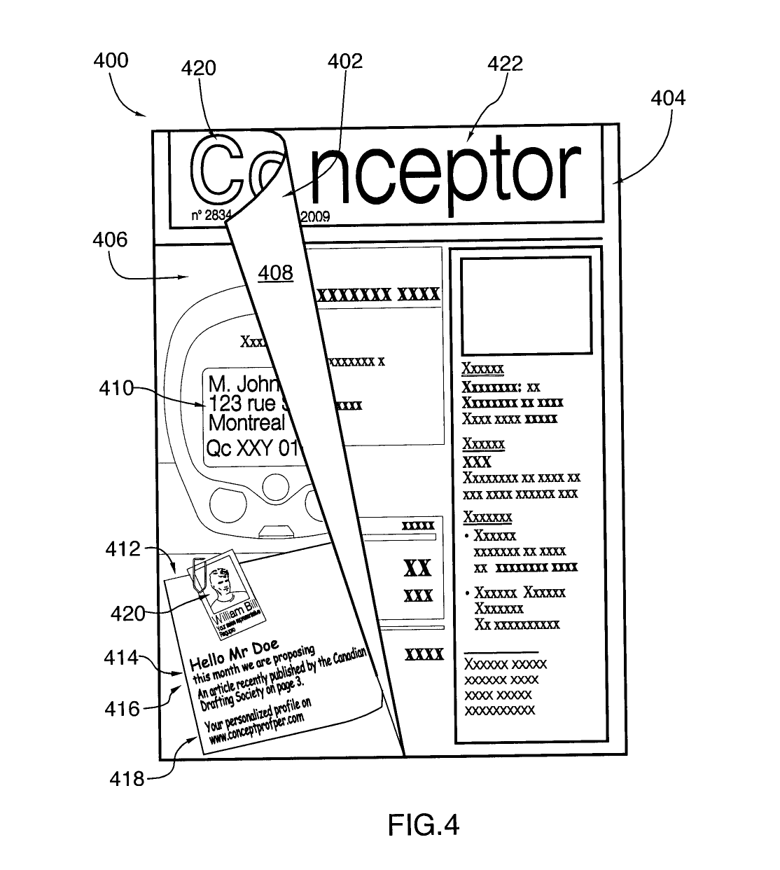

FIG. 4 shows another embodiment of, a printed matter 400 in the form of a magazine. In this embodiment, the printed matter comprises a personalizable attachment 402 in the form of a half-jacket partially covering a portion of a front cover page 404 of the printed matter 400. The half-jacket attachment 402 may, in addition, cover a portion or the entirety of a back cover page (not shown).

In this embodiment, the personalizable attachment 402 comprises a front face 406 and a back face 408. The front face 406 comprises a coordinate portion 410 similar to coordinate portion 36 of customized attachment 12 and displaying the same type of information (i.e. name and mailing address of the subscriber), and a marketing portion 412. The marketing portion 412 of the personalizable attachment 402 is similar to the marketing portion 38 of customized attachment 12 and displays a personalized greeting 414 to attract the attention of the subscriber, the magazine content that may be of particular interest for the subscriber 416 and a link to a website dedicated to the subscriber 418. The marketing portion may further include a picture of a customer representative assigned to the subscriber along with his contact information 420.

The information displayed on the personalized attachment 402 may further include complementary printed elements 420. The complementary printed elements 420 are designed to match and complement printing elements on the cover 404 when the half-jacket 402 is closed and lies thereon. As such, the complementary printed elements 420 may include a portion of the magazine title 422, issue, volume and the like. While in this embodiment complementary printed elements 420 are provided, a person skilled in the art will appreciate that they may not be required and may be omitted from the personalizable attachment 402.

The back face 408 of the personalizable attachment may also comprise personalized information. For instance, details on how to reach a specific advertiser or personalized driving direction to visit such advertiser or detachable coupons may be provided.

According to one embodiment, the attachment 402 is secured to the magazine so as to be part of the binding. As it will be appreciated by a person skilled in the art, gluing or any other method can be used to secure the attachment 402 to the cover page 404.

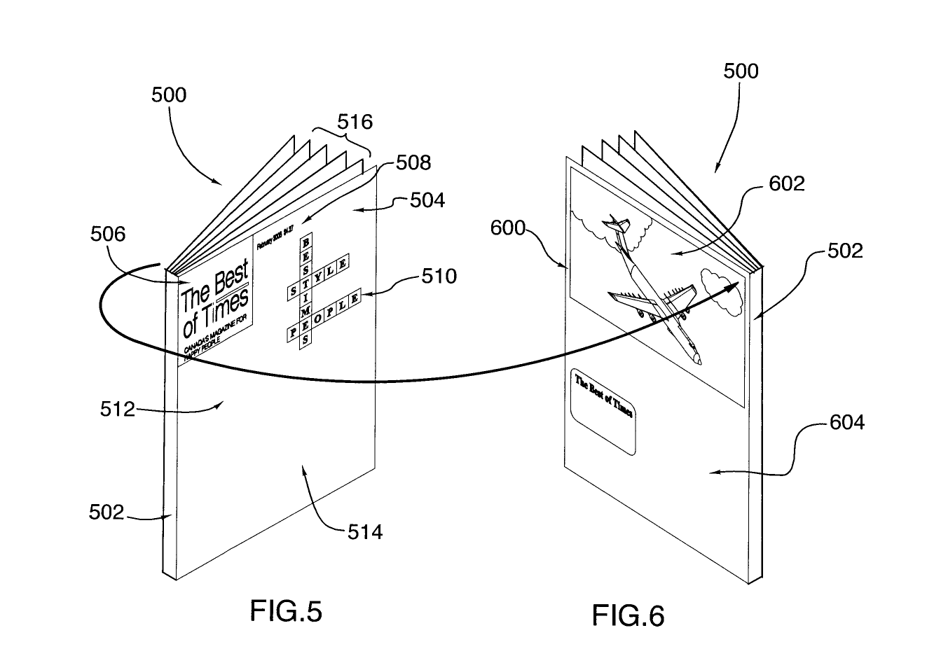

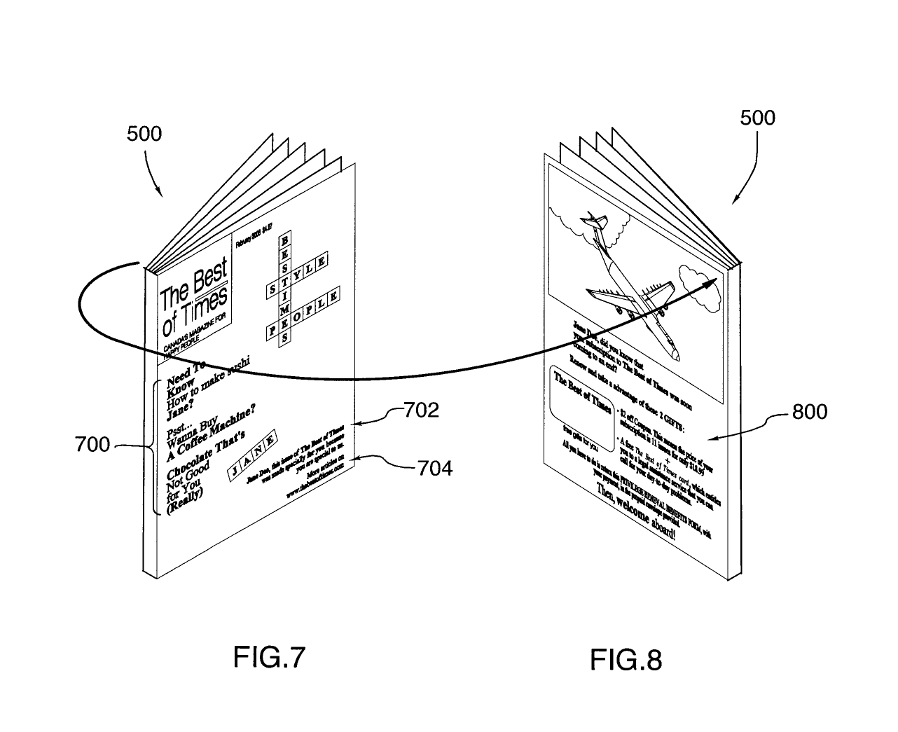

Now turning to FIGS. 5 to 8, a printed matter 500 in accordance with yet another embodiment is shown. In this embodiment, the printed matter 500 is in the form of a magazine comprising a cover 502 having a front page 504 and a back page 600, and a signature portion 501. Contrary to printed matters 10, 300 and 400, printed matter 500 does not include an attachment affixable to the cover 502. Rather, the personalized information is printed directly onto the cover 502. Accordingly, the cover 502 comprises information typically displayed on magazine covers such as the title of the magazine 506, the volume and issue 508, pictures 510, 602 and the like, which will appear on the printed matter 500 received by all subscribers. The cover 502 further comprises a plurality of personalizable spaces 512, 514 and 604 for further printing information and marketing material specific to each subscriber.

The personalized and marketing material information printed in the printable spaces 512, 514 and 604 comprises the magazine content that may be of particular interest for that subscriber 700 printed in space 512 as well as a personalized greeting 702 to attract the attention of the subscriber. In one embodiment, the magazine content that may be of interest for the subscriber 702 is presented in the questions and by inserting the subscriber's name in such questions. The personalized information also comprises a link to a web page dedicated to the subscriber 704 printed in space 514 as best described below. In this embodiment, the personalized information further comprises advertisement 800 from the magazine publisher offering the recipient to subscribe to the magazine and including personalized promotional offers printed in space 604 of the back page 600.

A person skilled in the art will thus appreciate that the cover 502 is the result of two subsequent printing, namely an offset printing of the material common to all subscriber (i.e. the title 506, volume and issue 508 and pictures 510, 602) and a digital printing of the customized information 700, 702, 704 and 800. The personalized cover 502 is then assembled to the signature portion 501 of the printed matter 500, as known in the art. For instance, the signature pages and the cover 502 can be assembled by perfect binding or saddle-stitching.

In an alternate embodiment, the cover 502 may be the result of only one printing step, whereby the material common to all subscriber (i.e. the title 506, volume and issue 508 and pictures 510, 602) and of the customized information 700, 702, 704 and 800 are printed simultaneously by digital printing or any other suitable method allowing personalization of the cover 502.

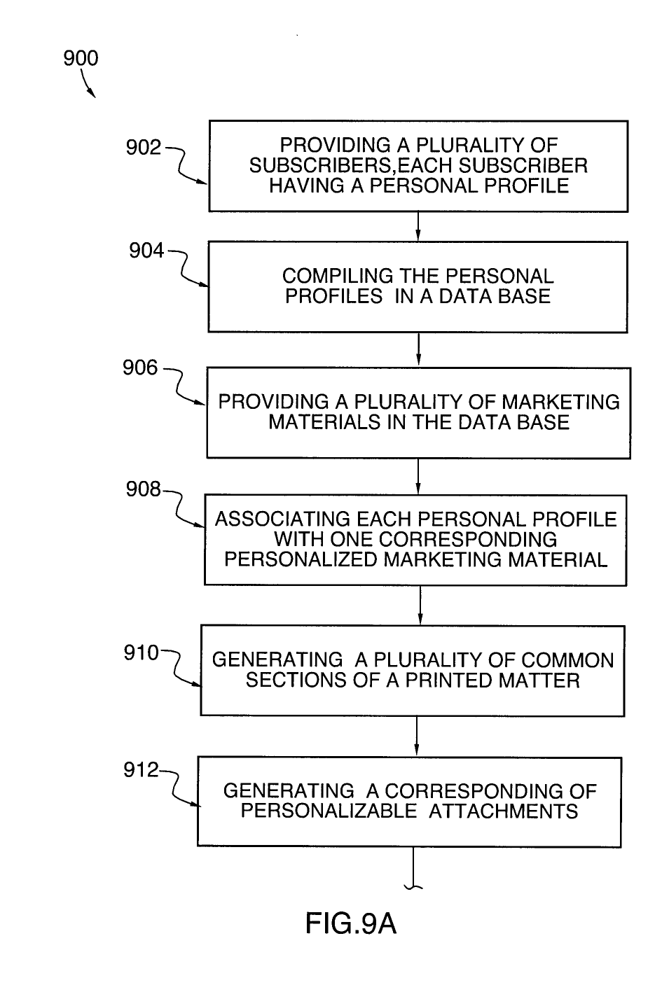

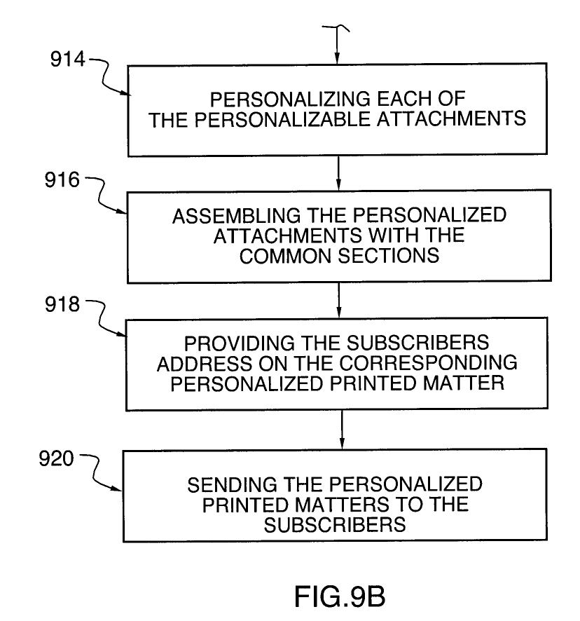

Having described personalized printed matters 10, 300, 400 and 500, a method for personalizing a printed matter, such as a magazine, will now be described with reference to FIG. 9.

According to one embodiment, the method 900 comprises: providing a plurality of subscribers, each of the subscribers having a personal profile, including a subscriber's mailing address (902); compiling the personal profiles of the subscribers in a database (904); providing a plurality of personalized marketing materials in the database (906); associating each of the personal profiles with one corresponding personalized marketing material (908); generating a plurality of common sections of a printed matter (910); generating a corresponding plurality of personalizable attachments (912); personalizing each of the personalizable attachments by printing one of the personalized marketing material thereon to thereby obtain a plurality of personalized attachments, (914); assembling each of the personalized attachements with one of the common sections to obtain a plurality of personalized printed matters (916); providing the mailing address of each of the subscribers on the personalized printed matter (918); and sending the personalized printed matters to the subscribers (920).

According to this embodiment, the subscribers' database is created using the name and contact information of the current subscribers of the magazine. The database comprises the personal profile of each subscriber, which preferably includes the name of the subscriber, his mailing address, phone number and other contact information. The personal profile may further comprise information that may be useful for targeting publicity, advertising and the like such as, for instance, a picture related to the subscriber, including his picture, responses given to a survey (e.g. favorite sport or hobby), the subscriber's place of birth, occupation, marital status and the like. As it will become apparent below, the subscriber's personal profile may further include information indicative of the web pages visited or more generally indicative of the browsing activity of the subscriber on a publisher website.

The information required to complete and update the personal profiles in the database can be obtained by way of surveys, collection at the time of subscription and the like. Alternatively, the information required to complete the personal profile may be obtained from loyalty marketing companies or in any other suitable manner.

The plurality of personalized messages is then created, preferably by a marketing team, and entered into the database. The personalized messages may include contents that may be of particular interest for a specific group of subscribers, personalized greetings, links toward dedicated web pages on a publisher website, advertisement and the like. The personalized messages are then associated with the personal profiles of the subscribers using different “matching” or “association” criteria, for later printing of the personal message on the personalizable section of the magazine.

In accordance with one embodiment, the subscribers' database is stored in a computer or a server in electronic communication with a printing system capable of efficiently printing a diversity of printing elements such as, for instance, a digital printing system. As it will become apparent below, the digital printing system is used to personalize the personalizable section of the magazine.

In the meantime, the common sections of the magazines are generated. With reference to printed matters 10, 300, 400, the common sections include the signature pages (14; not shown in FIGS. 3 and 4) as well as the cover pages (18, 304, 404, respectively). The common section of printed matter 500 comprises the signature pages, but not the cover 502, since in this particular embodiment the cover 502 corresponds to the personalizable section or attachment.

The personalizable attachments (i.e. personalized attachments 12, 302, 402 and cover 502 of printed matters 10, 300, 400 and 500, respectively) are also printed by offset printing.

As it will be appreciated by a person skilled in the art, the personalizable attachments are still not personalized at this stage. For doing so, the personalizable attachments are processed through a personalization step. In one embodiment, the personalization of each attachment is carried out by printing thereon the subscriber's name and mailing address and a personalized message selected on the basis of the subscriber's profile, (e.g. content that may be of particular interest, personalized greetings, links toward a website, advertisement and the like). In such an embodiment, personalizing the attachment and providing the mailing address of the subscriber are thus performed simultaneously.

In another embodiment, personalization of the personalizable attachment is carried out by printing the personalized message based on the subscriber's profile, with the exception of his mailing address. In this embodiment, the mailing address may be printed on a label, a sleeve or on a pocket such as a transparent pocket, and later affixed or packed with the personalized printed matter, as it will become apparent below. A person skilled in the art will appreciate that in such an embodiment, the binding and expedition processes must be adapted to match the label or pocket carrying the name and mailing address of the subscriber with the corresponding personalized printed matter. This may be achieved, for instance, by using scanning techniques or sequential processing (i.e. order of personalization of attachment corresponding to the order of printing of mailing addresses on labels).

In this embodiment, the step of providing the mailing address on the personalized printed matter may be carried out at different stages. For instance, where adhesive labels are used, the mailing address can be affixed to the personalized attachment prior to or after its assembly with the common section (i.e. the signature section). Where pockets or sleeves are used to package the personalized printed matter, the step of providing the mailing address is preferably performed after the assembly of the personalized attachment and the signature portion.

In one embodiment, the personal message comprises a link towards a web page on the publisher website. The term “web page” as intended herein is to be construed broadly so as to include any organized collection of information that can be accessed from a specific link on a private or public network. A person skilled in the art will appreciate that the organized collection of information can be static or dynamic and that it may include text, sound, picture, image and video medium or any combination thereof.

The personalized web pages may be part of the publisher's web site or include a link thereto. In this embodiment, the publisher's website is preferably configured so as to enable monitoring and tracking of the web pages visited by a subscriber on the publisher's website. The publisher's web site may also be configured to monitor and track other browsing behavior the subscriber may have. The information generated by monitoring the visited web pages visited or browsing behavior is preferably processed and uploaded in the personal profile of the subscriber. This additional information can then be used to generate further personalize the personalized message to be printed on the personalizable attachment.

The personalized web pages and the publisher's website are hosted on a web server or on any other controller configured for web hosting. The web server is preferably connected to a client's server and provides access to the personalized web pages through conventional web browsers using personal computers, portable phones, Personal Digital Assistants (PDA) or any other device configured for web browsing. While the web server and the client's server may be structurally distinct, a person skilled in the art will appreciate that a single server or controller may be configured to provide the functions the client's server and the web server.

In one preferred embodiment, each web page is dedicated or personalized to a specific subscriber and is aimed at providing additional marketing material, which material is preferably customized or personalized. For instance, the personalized web page may include a personalized video presentation which is conceived so that a presenter seemingly addresses the subscriber accessing his personalized web page. The personalized web page may further be configured so that the subscriber is presented information or promotional offers related to the magazine publisher, advertisers, promoter of the personalized web page or a combination thereof following the personalized video presentation. A person skilled in the art will appreciate that in some cases it may be difficult to provide video presentations personalized to each of the subscribers. In such circumstance, the personalized web page may include a video presentation that was prepared for a subgroup of subscribers or a general video presentation (i.e. a video presentation that is not personalized and that is found on all subscribers' web pages). Alternatively, the personalized web page may have no video content.

A person skilled in the art will appreciate that the web page may be configured differently. For instance, the personalized web page may be programmed so as to display a conventional graphical interface programmed using any well-known web programming. Web page creation, presentation and hosting are believed to be well-known by a person skilled in the art.

Personalization of the personalizable attachments is preferably carried out using a digital printer. A person skilled in the art will appreciate that personalization may be achieved using a variety of other printing processes. For instance, laser printing, ink jet and the like may be used.

The personalized printed matters are then distributed to subscribers, by regular mail, courier and the like. A person skilled in the art will, however, appreciate that distribution of printed matters, such as magazines, may occur other than by mailing to subscribers. For instance, magazines and newspapers are often distributed in newspaper stands, convenience stores and the like.

Accordingly, it may be desirable to provide alternatives to the personalized attachments to provide “uncustomized” or “unpersonalized” printed matters for distribution to non-subscribers. Therefore, according to one embodiment, the personalized attachment may be replaced by a more general attachment to fill spaces left blank (e.g. space 34 of printed matter 10), printing general marketing material directly in the spaces left blank (e.g. in spaces 512, 514 and 604 or printed matter 500) or, in some other instances, be omitted (e.g. with printed matters 300 and 400).

Although the foregoing description and accompanying drawings relate to specific embodiments of the present invention as presently contemplated by the inventor, it will be understood that various changes, modifications and adaptations, may be made.

We claim:

1. An attachment for personalizing a printed matter to a subscriber of said printed matter, the printed matter having a front page and a back page, the attachment comprising;
(a) a sheet of material sized and shaped for covering at least a portion of at least one of said top page and said bottom page;
(b) means for attaching said attachment to said printed matter such that said sheet of material covers at least a portion of said at least one of said top page and said bottom page; and
(c) at least one personalized marketing material printed on said sheet of material.

2. The attachment of claim 1, wherein said printed matter is selected from a group consisting of a magazine, a circular, a catalogue, a directory, a book, a pamphlet, and a newsletter.

3. The attachment of claim 1, wherein said sheet of material is selected from a group consisting of a sheet of paper, a sheet of cardboard, a sheet of plastic and a sheet of fabric.

4. The attachment as claimed in claim 1, wherein said attachment is selected from a group consisting of a label, a sleeve, a tab, a half-jacket and a cover.

5. The attachment as claimed in claim 1, wherein said personalized marketing material is selected from a group consisting of a personal greeting, a publicity targeted to the subscriber, a link to a personalized web page, an information relating to the subscriber and a printed matter content of interest for the subscriber.

6. The attachment as claimed in claim 1, further comprising a coordinate of the subscriber.

7. The attachment as claimed in claim 6, wherein said coordinate comprises at least one of a name of the subscriber and a mailing address.

8. The attachment as claimed in claim 1, wherein said means for attaching is selected from a group consisting of glue, staple, tape and insertion slots.

9. A method for personalizing a printed matter, the method comprising:
providing a plurality of subscribers, each of the subscribers having a personal profile comprising a mailing address;
compiling said personal profiles of said subscribers in a database;
providing a plurality of personalized marketing materials in said database;
associating each of said personal profiles with one corresponding personalized marketing material;
generating a plurality of common sections of a printed matter;
generating a corresponding plurality of personalizable attachments of said printed matter;
personalizing each of said personalizable attachments by printing thereon one of said personalized marketing material to thereby obtain a plurality of personalized sections, the personalized message printed on each personalizable section being selected based on the personal profiles;
assembling each of said personalized sections with one of the common sections to obtain a plurality of personalized printed matters;
providing said mailing address of each of the subscribers on said personalized printed matter; and
sending the personalized printed matters to the subscribers.

10. The method as claimed in claim 9, wherein said the mailing address of each of said subscriber is provided on said personalized attachment.

11. The method as claimed in claim 9, wherein said attachments are selected from a group consisting of a label, a sleeve, a tab, a half-jacket and a cover.

12. The method as claimed in claim 9, wherein said marketing materials are selected from a group consisting of a personal greeting, a publicity targeted to the subscriber, a link to a personalized web page, an information relating to the subscriber and a printed matter content of interest for the subscriber.
